(19) United States
(12) Patent Application Publication
(10) Pub. No.: US 2007/0147794 A1
(43) Pub. Date: Jun. 28, 2007

(54) Information processing apparatus and playback control method

(75) Inventor: Katsuhiko Araki, Hino-shi (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Kabushiki Kaisha Toshiba

(21) Appl. No.: 11/603,373

(22) Filed: Nov. 22, 2006

(30) Foreign Application Priority Data
Dec. 27, 2005 (JP) 2005-375202

(51) Int. Cl. H04N 5/00

(52) U.S. Cl. 386/125

(57) ABSTRACT

According to one embodiment, an information processing apparatus is capable of playing back moving picture data from a disc medium of a two-layer structure. The apparatus includes an estimation processing portion to estimate an available time to play back the moving picture data item stored in the first recording layer by power from the battery and an available time to play back the moving picture data item stored in the second recording layer by power from the battery, based on an amount of charge remaining in the battery, a display processing portion to display results of estimation by the estimation processing portion on a display screen of the information processing apparatus, and a playback control portion to play back one selected by a user from the moving picture data item stored in the first recording layer and the moving picture data item stored in the second recording layer.

### CROSS-REFERENCE TO RELATED APPLICATIONS

This application is based upon and claims the benefit of priority from Japanese Patent Application No. 2005-375202, filed Dec. 27, 2005, the entire contents of which are incorporated herein by reference.

### BACKGROUND

1. Field

One embodiment of the invention relates to an information processing apparatus, such as a personal computer, which can be driven by a battery and plays back moving picture contents stored in a disc medium having a two-layer structure, and also to a playback control method for use in the apparatus.

2. Description of the Related Art

In recent years, various information processing apparatuses, such as personal computers, have been developed, which can play back moving picture contents stored in digital versatile discs (DVDs). Some types of the computers are portable. The portable computers are driven by batteries. In a battery-driven computer, the amount of charge in the battery is reduced during playback of moving picture contents, and sometimes the contents cannot be played back to the end.

Jpn. Pat. Appln. KOKAI Publication No. 2001-319407 discloses a music playback apparatus, which plays back a plurality of music data files containing the same music data compressed at different compression rates. The music playback apparatus has a plurality of operation modes of different power consumptions. In a power saving mode, the music playback apparatus plays back a music data file for a low power consumption (data of a low sound quality compressed at a high compression rate). As a result, the battery lifetime can be extended.

The battery-driven portable computer has a function of calculating a time, for which the computer can continue to operate, based on the amount of charge remaining in the battery. With this function, the user can recognize how long the computer can continue to operate. However, when a moving picture content is to be played back by the portable computer, it is difficult for the user to estimate how long the computer can continue to play back the moving picture content only based on the amount of charge remaining in the battery.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view showing an exterior of an information processing apparatus according to an embodiment of the present invention;

FIG. 2 is an exemplary block diagram showing an example of the system configuration of the information processing apparatus shown in FIG. 1;

FIG. 3 is an exemplary block diagram for explaining a function configuration of a system controlling processor in the information processing apparatus shown in FIG. 1;

FIG. 4 is an exemplary diagram showing an example of a sectional structure of a disc medium in an example of playback processing executed by the information processing apparatus shown in FIG. 1;

FIG. 5 is an exemplary diagram for explaining an example of a content list produced by the information processing apparatus shown in FIG. 1;

FIG. 6 is an exemplary diagram for explaining an example of power consumption information defining an amount of power consumption for each of the types of format set in advance by the information processing apparatus shown in FIG. 1;

FIG. 7 is an exemplary diagram showing an example of details of an imaging picture data item under playback, which is displayed on a display screen of the information processing apparatus shown in FIG. 1;

FIG. 8 is an exemplary diagram of an example of a message indicating that the moving picture data item under playback, which is displayed on a display screen of the information processing apparatus shown in FIG. 1, cannot be played back continuously to the end;

FIG. 9 is an exemplary flowchart for explaining a first part of the procedures of playback processing executed by the information processing apparatus shown in FIG. 1; and

FIG. 10 is an exemplary flowchart for explaining a second part of the procedures of playback processing executed by the information processing apparatus shown in FIG. 1.

### DETAILED DESCRIPTION

Various embodiments according to the invention will be described hereinafter with reference to the accompanying drawings. In general, according to one embodiment of the invention, an information processing apparatus is capable of playing back moving picture data from a disc medium of a two-layer structure. The apparatus includes an estimation processing portion to estimate an available time to play back the moving picture data item stored in the first recording layer by power from the battery and an available time to play back the moving picture data item stored in the second recording layer by power from the battery, based on an amount of charge remaining in the battery, a display processing portion to display results of estimation by the estimation processing portion on a display screen of the information processing apparatus, and a playback control portion to play back one selected by a user from the moving picture data item stored in the first recording layer and the moving picture data item stored in the second recording layer.

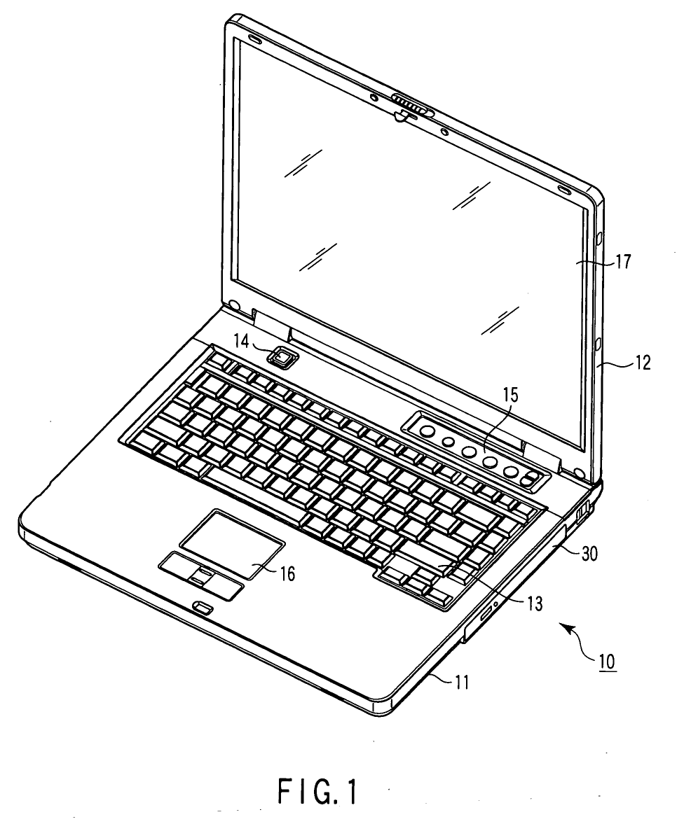

FIG. 1 shows an exterior of an information processing apparatus according to an embodiment of the present invention. The information processing apparatus is implemented as a portable personal computer 10, which is, for example, configured to be driven by a battery and plays back moving picture contents stored in a disc medium. In this embodiment, the computer 10 has a function of playing back a moving picture content (for example, moving picture data) stored in, for example, a disc medium having a two-layer structure (a disc medium having two recording layers on one side or a disc medium having one recording layer on each side). The disc medium stores a plurality of moving picture data items having different resolutions for each of video titles. One of the recording layers of the disc medium stores a plurality of high-quality (high-resolution) moving picture data items respectively corresponding to the video titles. The other of the recording layers of the disc medium stores a plurality of standard-quality (standard-resolution) moving picture data items respectively corresponding to the video titles. The high-quality and standard-quality moving picture data items, which correspond to the same video title, are composed on the basis of the same image source. The type of format of each moving picture data item is determined by the combination of a resolution, a bit rate and a compressed format. The resolution represents sizes (a size in the horizontal direction and a size in the vertical direction) of each of a plurality of frames constituting a moving picture data item. The bit rate represents the amount of data transmitted per unit time. The compressed format represents a compression coded format of a moving picture data item.

The image of each moving picture data item significantly varies depending on the resolution. The computer 10 of this embodiment has a display function of displaying a playback available time, in which the power from the battery allows playback of high-quality (high-resolution) moving picture data item and standard-quality (standard-resolution) moving picture data items corresponding to a video title, based on the amount of charge remaining in the battery. The playback available time is displayed on a display screen of the computer 10. Power consumption information, which indicates power consumption per unit time for each of the types of format of moving picture data, is determined in advance for each of the resolutions. When the user selects a moving picture data item to be played back from the video titles displayed on the display screen of the computer 10, playback processing to playback the selected moving picture data item is carried out.

If the amount of charge remaining in the battery is reduced below a predetermined threshold value during the playback of a high-quality moving picture data item, the computer 10 displays a screen through which the user can input an instruction for switching the playback of the high-quality moving picture data item in midstream to playback of a standard-quality moving picture data item of the same video title. If the user inputs an instruction for switching the playback of the high-quality moving picture data item in midstream to playback of a standard-quality moving picture data item, the computer 10 switches the playback of the high-quality moving picture data item in midstream to playback of a standard-quality moving picture data item of the same video title.

FIG. 1 is a perspective view, showing a state in which a display unit of the computer 10 is open. The computer 10 comprises a main body 11 and a display unit 12. The display unit 12 incorporates a display device comprising a liquid crystal display (LCD) panel 20. The display screen of the LCD panel 20 is located substantially in the central portion of the display unit 12.

The display unit 12 is supported by the main body 11. The display unit 12 is rotatable relative to the main body 11 between an open position in which the upper surface of the main body 11 is exposed and a closed position in which the display unit 12 covers the upper surface of the main body 11. The main body 11 has a thin box-shaped casing, and incorporates an optical disc drive 30, for example, in the sidewall portion. An operation switch group 15, provided on the upper surface of the main body 11, includes a power button switch 14 to power on the computer 10 and a button switch group to control playback operations of the optical disc drive 30. Further, an analog image output portion and an analog sound output portion are provided, for example, on a back surface of the main body 11.

The operation switch group 15 includes a button switch to play back and stop moving picture data, a fast-forward button switch to fast forward moving picture data, a fast-reverse button switch to fast reverse moving picture data, etc. The optical disc drive 30 drives a recording medium, such as a digital versatile disc (DVD) and a compact disc (CD), and reads moving picture from the disc medium. The analog image output portion 18 is an output portion to output image signals to an external device. The analog sound output portion 19 is an output portion to output sound signals to an external device.

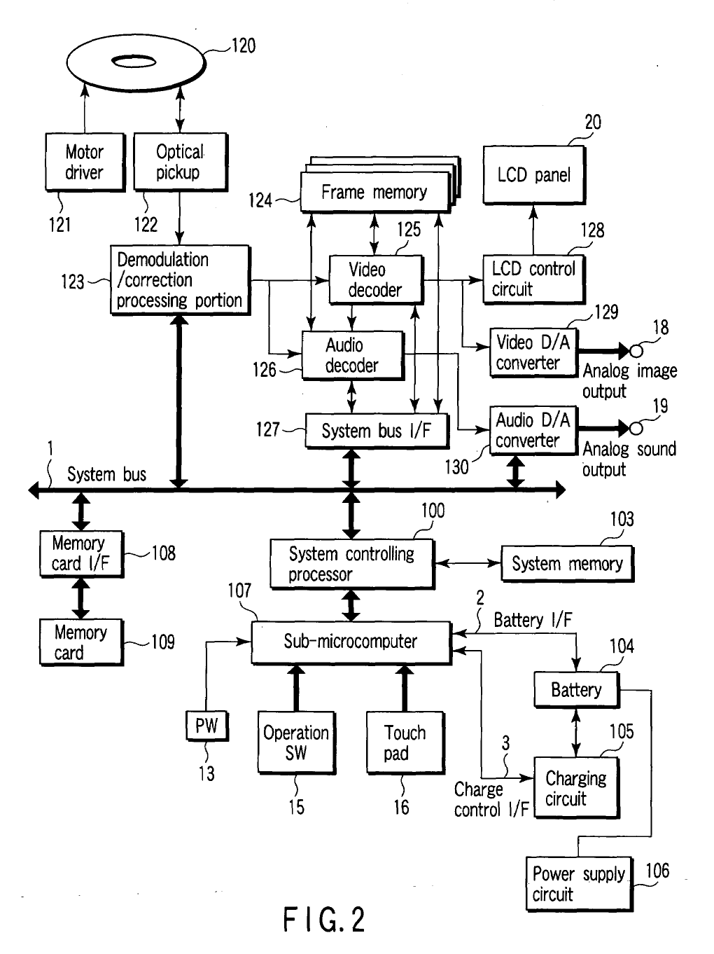

The system configuration of the computer 10 will now be described with reference to FIG. 2.

The computer 10 comprises a system controlling processor 100, a system memory 103, a battery 104, a charging circuit 105, a power supply circuit 106, a sub-microcomputer 107, a memory card interface 108, a motor driver 121, an optical pickup 122, a demodulation/correction processing portion 123, a frame memory 124, a video decoder 125, an audio decoder 126, a system bus interface 127, an LCD control circuit 128, a video D/A converter 129, an audio D/A converter 130, etc.

The system controlling processor 100 controls each of the components of the computer 10. The system controlling processor 100 reads power consumption information stored in the system memory 103. It also reads content information stored in a disc medium 120. If the disc medium 120 is, for example, a double-sided disc medium, which has a recording layer on each of the recording surfaces, the content information is stored in each of a recording layer #1 formed on one recording surface and a recording layer #2 formed on the other recording surface. The content information is indicative of details (the video title name, the compressed format of the moving picture data, the playback time from the beginning to the end of the moving picture data, etc.) of each of moving picture data items stored in the recording layer #1 and moving picture data items stored in the recording layer #2.

The sub-microcomputer 107 receives an operation request input through the operation switch group 15 etc., and notifies the system controlling processor 100 of the received operation request. The battery 104 is connected to the sub-microcomputer 107 via a battery interface 2. The charging circuit 105 is connected to the sub-microcomputer 107 via a charge control interface 3. The sub-microcomputer 107 detects the amount of charge remaining in the battery 104 through the battery interface 2, and notifies the system controlling processor 100 of the detected amount of charge remaining in the battery 104. The charging circuit 105 and the power supply circuit 106 are connected to the battery 104. The charging circuit 105 supplies to the battery 104 the electric power supplied from an external device through an AC adapter or the like connected to computer 10. Thus, the charging circuit 105 charges the battery 104. The power supply circuit 106 generates power to be supplied to the components of the computer 10 from power of the battery 104, when the user depresses the power button switch 14. A memory card 109 is connected to the system bus 1 via the memory card interface 108. The memory card 109 functions as a storage device for storing data or the like.

The optical disc drive 30 comprises the motor driver 121 and the optical pickup 122. The motor driver 121 rotates the disc medium 120. The optical pickup 122 radiates a laser beam onto the disc medium 120 and acquires an audio video (AV) signal from the reflected laser beam. The optical pickup 122f also acquires information indicative of details of the moving picture contents stored in the disc medium 120 from the reflected laser beam. The demodulation/correction processing portion 123 demodulates the AV signal acquired by the optical pickup 12, and corrects the demodulated AV signal. Further, the demodulation/correction processing portion 123 separates the demodulated and corrected AV signal into moving picture data and sound data. Then, it transmits the moving picture data to the video decoder 125, and the sound data to the audio decoder 126. The video decoder 125 decodes the moving picture data, and transmits the decoded moving picture data to the LCD control circuit 128 and the video D/A converter 129. The LCD control circuit 128 generates a display signal to display the moving picture data transmitted from the video decoder 125 in the LCD panel 20. The video D/A converter 129 outputs to an external device the moving picture data, which has been transmitted from the video decoder 125. The audio decoder 126 decodes sound data, and outputs the decoded sound data via the audio D/A converter 130 to a speaker provided outside or in the computer 10.

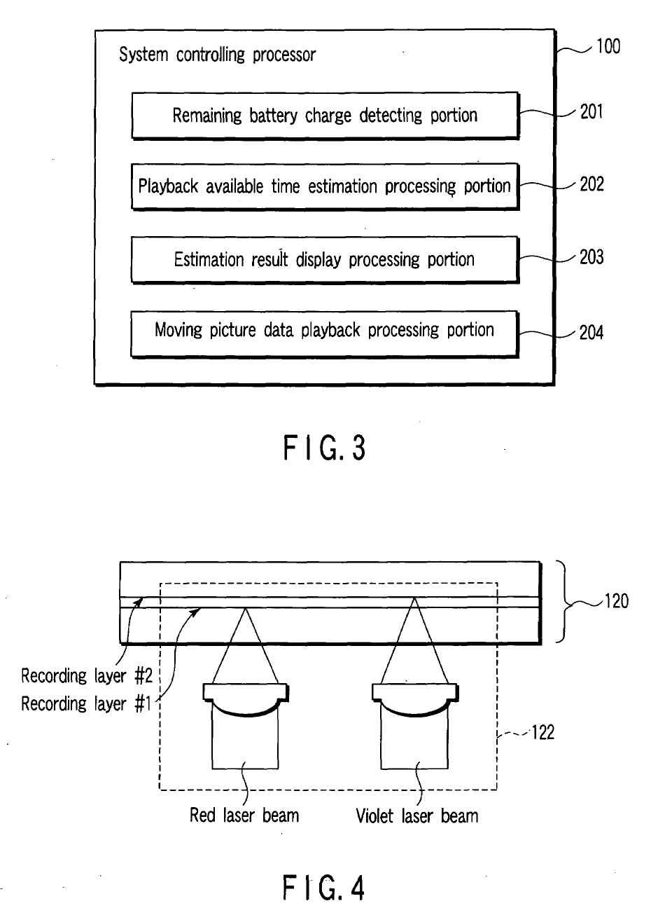

Functions of the system controlling processor 100 will now be described with reference to FIG. 3. The system controlling processor 100 comprises a remaining battery charge detecting portion 201, a playback available time estimation processing portion 202, an estimation result display processing portion 203 and a moving picture data playback processing portion 204. The remaining battery charge detecting portion 201 executes a process of detecting the amount of charge remaining in the battery 104. The playback available time estimation processing portion 202 estimates an available time to play back each of the moving picture data items stored in the disc medium 120 by the power from the battery 104. The estimation is performed on the basis of the type of format (resolution etc.) of the moving picture data item, the amount of charge remaining in the battery 104 detected by the remaining battery charge detecting portion 201, and the power consumption information. The estimation result display processing portion 203 causes the LCD panel 20 to display a content list. The content list indicates the video title name of each moving picture data item, an estimated playback available time in which the moving picture data item can be played back by the power supplied from the battery 104 and whether the data item can be played back to the end. If the amount of charge remaining in the battery 104 detected by the remaining battery charge detecting portion 201 is less than a predetermined threshold value, the estimation result display processing portion 203 causes the LCD panel 20 to display an alarm message that it is difficult to continuously play back the moving picture data item. Further, the estimation result display processing portion 203 causes the LCD panel 20 to display a screen to input an instruction for switching the playback of the high-quality moving picture data item in midstream to playback of a standard-quality moving picture data item. The estimation result display processing portion 203 determines whether the subject moving picture data item selected by the user can be acquired from the disc medium 120. If not, the estimation result display processing portion 203 causes the LCD panel to display a message to lead the user to turn over the disc medium 120 so that the recording layer storing the subject moving picture data item can be read. This is because the disc medium 120 need be turned over so that the recording layer storing the subject moving picture data item can be read, if the disc medium 120 has a recording layer on each of the surfaces; that is, if high-quality moving picture data items are stored in one of the recording layers of the disc medium, while standard-quality moving picture data items are stored in the other recording layer. The moving picture data playback processing portion 204 plays back the moving picture data item selected by the user.

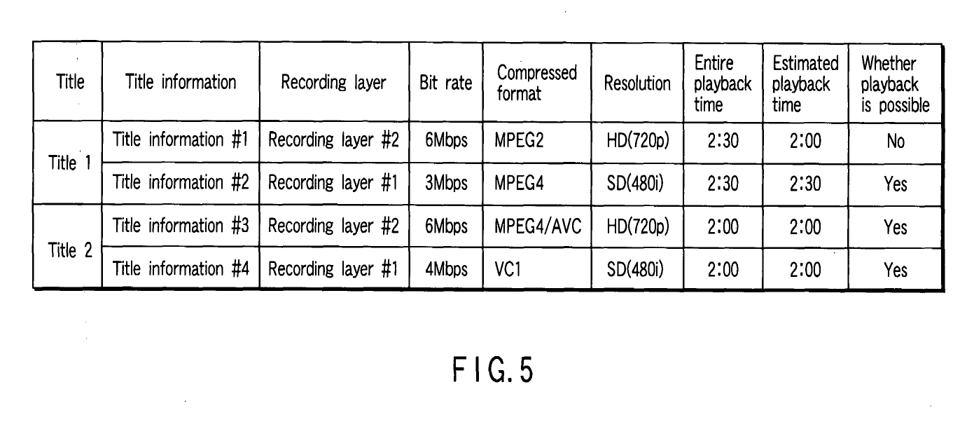

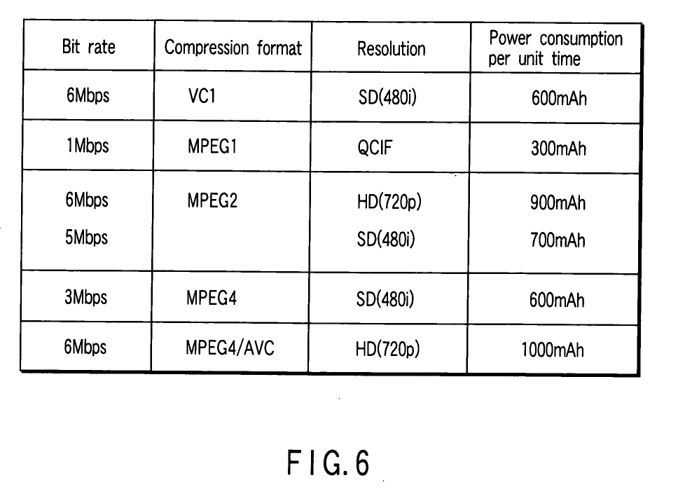

FIG. 4 shows an example of a sectional structure of the disc medium 120. The disc medium 120 has two layers: a recording layer #1 and a recording layer #2. The recording layer #1 is formed on one recording surface, and the recording layer #2 is formed on the other recording surface. The computer 10 calculates a playback available time for each of the moving picture data items stored in the disc medium having the two recording layers based on the amount of charge remaining in the battery 104 and the type of format (resolution etc.) of each moving picture data item, and displays a content list on the LCD panel 20. Further, if the computer 10 determines that the amount of charge remaining in the battery is reduced below the predetermined threshold value during the playback of a moving picture data item stored in, for example, the recording layer #2, the computer 10 displays a screen through which the user can input an instruction for switching the playback of the moving picture data item stored in the recording layer #2 to playback of a moving picture data item stored in the recording layer #1. If the user inputs an instruction for switching the playback of the moving picture data item stored in the recording layer #2 to playback of a moving picture data item stored in the recording layer #1, the computer 10 switches the playback of the playback of the moving picture data item stored in the recording layer #2 to playback of a moving picture data item stored in the recording layer #1.

The recording layer #1 can be read by a normal DVD drive using, for example, a red laser beam. The recording layer #1 stores moving picture data items having a resolution of, for example, standard definition (SD), for each of the video titles. The recording layer #2 can be read by an HD DVD drive using, for example, a violet laser beam. The recording layer #2 stores moving picture data items having a resolution of, for example, high definition (HD), for each of the video titles.

The optical pickup 122 of the optical disc drive 30 is a DVD/HD DVD-compatible optical head. It can read either the recording layer #1 or the recording layer #2 by selectively using the red laser beam or the violet laser beam. The optical pickup 122 reads the aforementioned content information stored in each of the recording layer #1 and the recording layer #2 by selectively using the red laser beam or the violet laser beam.

In this embodiment, a DVD/HD DVD-compatible recording disk and a DVD/HD DVD-compatible optical head are used. However, it is possible to use a disc medium having a recording layer #1 and a recording layer #2, both of which can be read by a violet laser beam, and an HD DVD optical head which can read the two recording layers in the disc medium.

An example of the content list will be described with reference to FIG. 5. As shown in FIG. 5, the content list includes items “title”, “recording layer”, “title information”, “bit rate”, “compressed format”, “resolution”, “entire playback time”, “estimated playback time” and “whether playback is possible”, for each of the moving picture data items. The item “title” indicates a title of, for example, a moving picture data item. The item “title information” indicates an identifier to identify a moving picture data item. The item “recording layer” indicates a recording layer which stores a moving picture data item. The item “bit rate” indicates a bit rate of a moving picture data item. The item “compressed format” indicates a compression coded format of a moving picture data item. The item “resolution” indicates resolution of a moving picture data item. Examples of “resolution” are “SD (480i)” indicative of the resolution of an interlace image of SD standard and “HD (720p)” indicative of the resolution of a progressive image of HD standard. The item “entire playback time” indicates the length of playback time from the beginning to the end of a moving picture data item. The item “estimated playback time” indicates the length of playback time, in which the moving picture data item can be played back by the power from the battery 104. The item “whether playback is possible” indicates whether the moving picture data item can be played back from the beginning to the end by the power from the battery 104.

The disc medium 120 stores two moving picture data items corresponding to a video title 1 and two moving picture data items corresponding to a video title 2. The two moving picture data items corresponding to the video title 1 is a moving picture data item corresponding to title information #1 stored in the recording layer #2 and a moving picture data item corresponding to title information #2 stored in the recording layer #1. The two moving picture data items corresponding to the video title 2 is a moving picture data item corresponding to title information #3 stored in the recording layer #2 and a moving picture data item corresponding to title information #4 stored in the recording layer #1.

The two moving picture data items corresponding to the video title 1 (the moving picture data item corresponding to the title information #1 and the moving picture data item corresponding to the title information #2) are structured from one image source, the entire playback time of which is two hours and thirty minutes. The two moving picture data items corresponding to the video title 2 (the moving picture data item corresponding to the title information #3 and the moving picture data item corresponding to the title information #4) are structured from one image source, the entire playback time of which is two hours.

For example, the image picture data item corresponding to the title information #1 is an image picture data item having a type of format defined by the combination of the bit rate of 6 Mbps, the compressed format of MPEG2 and the resolution of HD standard. As for the moving picture data item corresponding to the title information #1, the entire playback time is two hours and thirty minutes, whereas the estimated playback time is two hours. Therefore, the item “whether playback is possible” of the moving picture data item corresponding to the title information #1 is assigned the mark “No” by the system controlling processor 100.

The image picture data item corresponding to the title information #2 is an image picture data item having a type of format defined by the combination of the bit rate of 3 Mbps, the compressed format of MPEG4 and the resolution of SD standard. As for the moving picture data item corresponding to the title information #2, the entire playback time is two hours, and the estimated playback time is also two hours. Therefore, the item “whether playback is possible” of the moving picture data item corresponding to the title information #2 is assigned the mark “Yes” by the system controlling processor 100.

Next, an example of power consumption information will be described with reference to FIG. 5. As shown in FIG. 5, power consumption information indicates power consumption per unit time for each of the types of format of moving picture data.

Assuming that a moving picture data item has a type of format defined by the combination of the bit rate of 6 Mbps, the compressed format of VC1 (Video Coding) and the resolution of SD (480i) standard, the power consumption per unit time is 600 mA. The power consumption information is prestored in, for example, the system memory 103. Actually, the power consumption per unit time is calculated in consideration of not only the type of format but also operation power for the computer 10. The operation power for the computer 10 includes power consumed by the LCD panel 20 of the computer 10, which depends on the degree of contrast of the panel, and power consumed by the speaker mounted in the computer 10, which depends on the volume of sound output from the speaker.

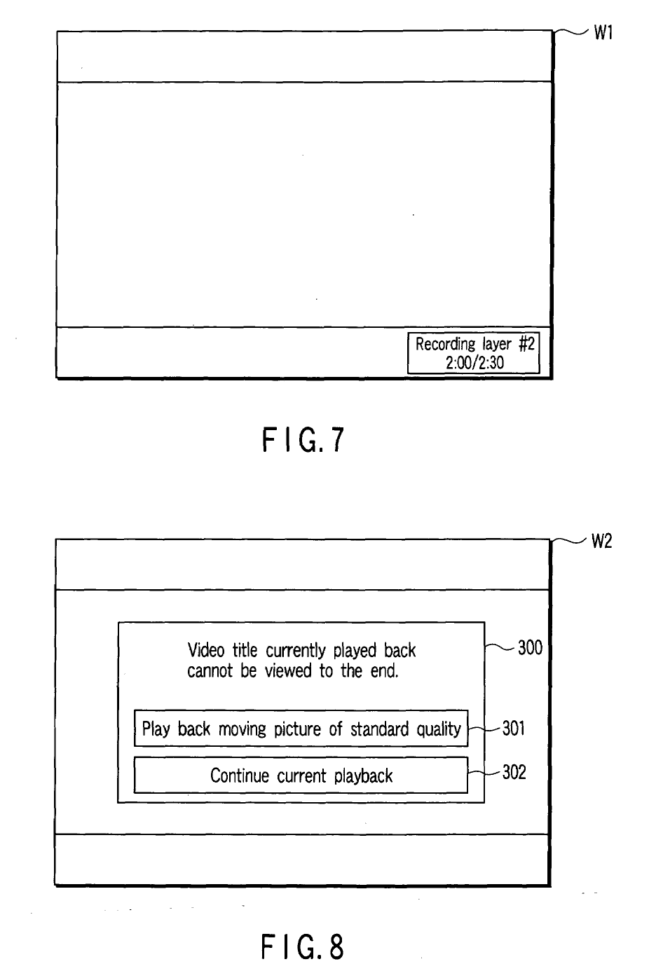

If the user selects a subject moving picture data item from the content list displayed on the LCD panel 20, the LCD panel 20 displays details of the items of the subject moving picture data item (the recording layer, the estimated playback time, the entire playback time, etc.). FIG. 7 shows an example of a display window W1 of the LCD panel 20 showing details of the items of the subject imaging picture data selected by the user. The user can visually recognize a time in which the subject moving picture data can be played back based on the amount of charge remaining in the battery 104. Further, the user can select a moving picture data item to be played back from the content list displayed on the LCD panel 20.

The computer 10 displays a window W2 on the LCD panel 20, as shown in FIG. 8, if it determines that the amount of charge remaining in the battery is less than the predetermined threshold value when the moving picture data item stored in the recording layer #2 is played back. The window W2 includes a window 300 indicating a message that the moving picture data item currently played back cannot be viewed to the end. The window 300 further includes a button 301 and a button 302, which inquire of the user whether to switch the playback of the moving picture data item stored in the recording layer #2 to the moving picture data item stored in the recording layer #1. The button 301 has a function of instructing playback of the moving picture data item stored in the recording layer #1 in midstream of the playback of the moving picture data item stored in the recording layer #2. If the user presses the button 301 by, for example, operating a key of a keyboard 13, in midstream of the playback of the moving picture data item stored in the recording layer #2, the system controlling processor 100 causes the system memory 103 or the like to store the video title and the playback position information of the video title currently played back. Based on the playback position information stored in the system memory 103 or the like, the system controlling processor 100 plays back the moving picture data item stored in the recording layer #1.

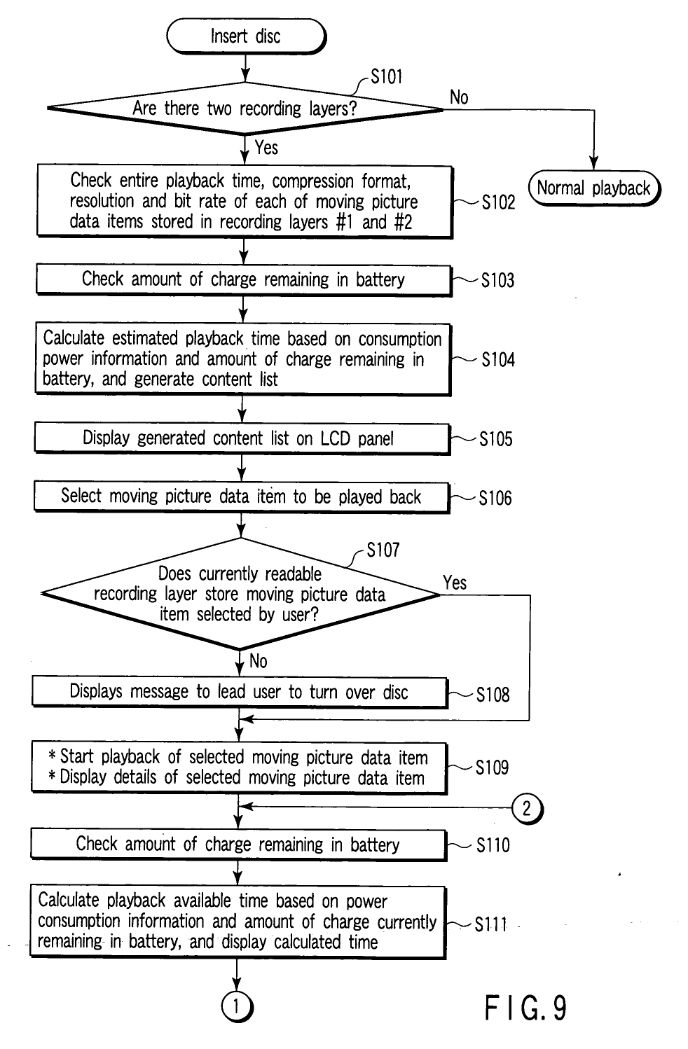

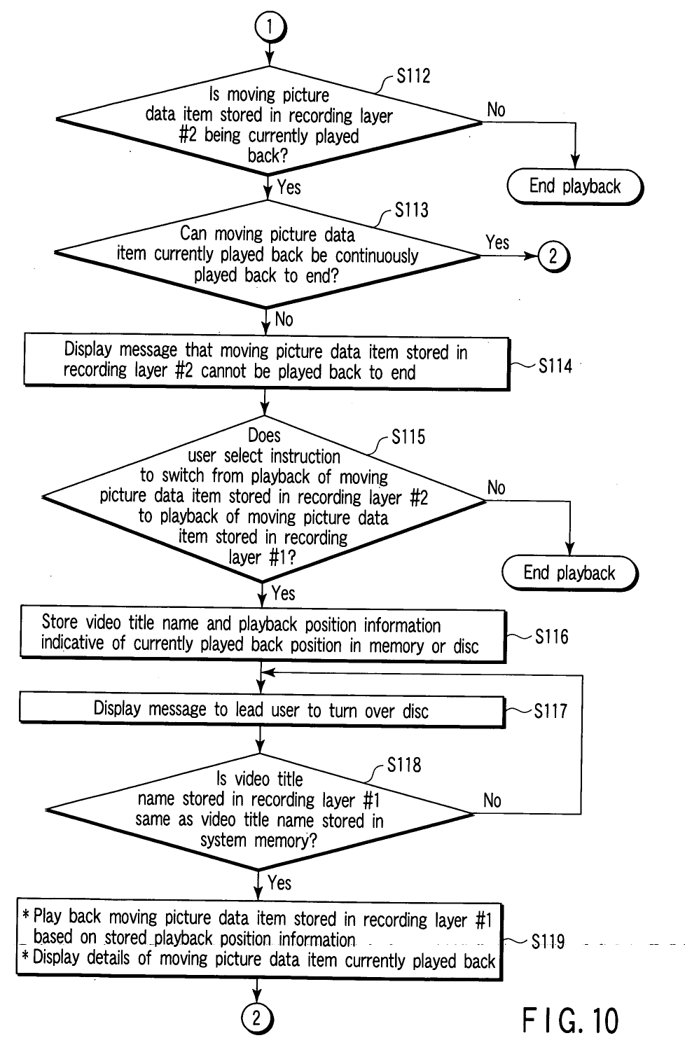

Procedures of moving picture data playback processing executed by the computer 10 will now be described with reference to the flowcharts shown in FIGS. 9 and 10. When the disc medium 120 is inserted in the optical disk drive 30, the system controlling processor 100 determines whether the inserted disc medium 120 has two recording layers (block S101). In the block S101, if the inserted disc medium 120 is of a type having two recording layers on one recording surface, the optical pickup 122 irradiates the inserted disc medium 120 selectively with a red laser beam or a violet laser beam. If the inserted disc medium 120 is of a type having one recording layer on each of the recording surfaces, the optical pickup 122 irradiates the readable recording surface selectively with a red laser beam or a violet laser beam, and acquires content information stored in the recording surface of the disc medium 120 through the reflected laser beam. If the radiated violet laser beam is reflected by the recording layer #2 of the disc medium 120 (if content information is contained in a signal acquired by reflecting the irradiated laser beam), the system controlling processor 100 determines that the recording medium 120 has the recording layer #2. On the other hand, if the radiated violet laser beam is not reflected by the recording layer #2 (if content information is not contained in a signal acquired by reflecting the irradiated laser beam), the system controlling processor 100 determines that the recording medium 120 has only one recording layer (NO in the block S101). In this case, the system controlling processor 100 plays back the moving picture data stored in the recording layer.

If the system controlling processor 100 determines that the recording medium 120 has the two recording layers (YES in the block S101), it obtains AV signals respectively from the recording layer #1 and the recording layer #2 of the disc medium 120, and checks the entire playback time, a type of format (bit rate, resolution and compressed format) of each of the moving picture data items and a recording layer that stores the moving picture data item (block S102). In the block S102, if the disc medium 120 has one recording layer on each of the recording surfaces, the system controlling processor 100 acquires content information stored in the recording layer of either side, and checks the entire playback time and a type of format (bit rate, resolution and compressed format) of each of the moving picture data items based on the acquired content information.

The system controlling processor 100 checks the amount of charge currently remaining in the battery 104 (block S103). The system controlling processor 100 calculates an estimated playback time of each moving picture data item based on the consumption power information and the checked amount of charge remaining in the battery 104, and generates a content list based on the calculation results (block S104). The system controlling processor 100 displays the generated content list on the LCD panel 20 (block S105). In the block S105, the system controlling processor 100 displays the estimated playback time, whether the playback is possible or not, the recording layer storing the moving picture data item corresponding to the video title on a on-screen display (OSD), etc., if necessary. The user selects a video title to be played back from a plurality of video titles displayed on the LCD panel 20 (block S106). The system controlling processor 100 determines whether the currently readable recording layer stores the moving picture data item selected by the user (block S107). If the system controlling processor 100 has acquired the content information from the disc medium 102, it determines in the block S107 whether the currently readable recording layer of the disc medium stores the moving picture data item selected by the user based on the acquired content information. If the system controlling processor 100 determines that the currently readable recording layer of the disc medium does not store the moving picture data item selected by the user (that is, the other recording layer stores the selected moving picture data item) (NO in block S107), the system controlling processor 100 displays a message to lead the user to turn over the disc medium 120 (block S108).

On the other hand, if the moving picture data item selected by the user can be displayed or the recording layer storing a moving picture data item that can be played back is readable, the system controlling processor 100 starts playback of the selected moving picture data item and displays the details of the selected moving picture data item (the video title name, the entire playback time, the estimated playback time, the recording layer, etc.) (block S109).

During the playback of the moving picture data item, the system controlling processor 100 checks the amount of charge remaining in the battery 104 (block S110). The system controlling processor 100 calculates a continuous playback available time based on the power consumption information and the amount of charge currently remaining in the battery 104, and displays the calculated time on the LCD panel 20 (block S111). The system controlling processor 100 determines whether the moving picture data item stored in the recording layer #2 is being currently played back or not (block S112 in FIG. 10). If it is determined that the moving picture data item currently played back is not the moving picture data item stored in the recording layer #2 (that is, the moving picture data item currently played back is the moving picture data item stored in the recording layer #1) (NO in block S112), the system controlling processor 100 continues playback of the moving picture data item.

If it is determined that the moving picture data item currently played back is the moving picture data item stored in the recording layer #2 (YES in the block S112), the system controlling processor 100 determines whether the moving picture data item currently played back can be continuously played back to the end on the basis of the amount of charge remaining in the battery 104, the estimated playback time of the moving picture data item and the remaining playback time of the moving picture data item (block S113). If it is determined that the moving picture data item currently played back can be continuously played back to the end (YES in the block S113), the systems controlling processor 100 checks the battery remaining charge again, for example, after a predetermined time elapses (the block S110 in FIG. 8).

If it is determined that the moving picture data item currently played back cannot be continuously played back to the end (NO in the block S113), the system controlling processor 100 causes the LCD panel 20 to display a message that the moving picture data item stored in the recording layer #2 cannot be played back to the end (block S114). In the block S114, the system controlling processor causes the LCD panel 20 to display a screen to select either continuous playback of the moving picture data item stored in the recording layer #2 or an instruction to switch to the playback of the moving picture data item stored in the recording layer #1 in midstream of the playback.

If the user does not select the instruction to switch from the playback of the moving picture data item stored in the recording layer #2 to the playback of the moving picture data item stored in the recording layer #1 (NO in block S115), the system controlling processor 100 continues the playback of the moving picture data item currently played back. On the other hand, if the user selects the instruction to switch from the playback of the moving picture data item stored in the recording layer #2 (e.g., the moving picture data item having a resolution of HD) to the playback of the moving picture data item stored in the recording layer #1 (e.g., the moving picture data item having a resolution of SD), that is, if the user presses the button on the LCD panel 20 to playback the standard-quality moving picture data item (YES in block S115), the system controlling processor 100 causes the system memory 103 or a disc medium, such as a DVD-RAM, to store the video title name of the moving picture data item currently played back and the playback position information indicative of the currently played-back position (the position of the chapter currently played back or the time elapsed from the start of the playback process) (block S116). The system controlling processor 100 causes the LCD panel 20 to display a message to lead the user to turn over the disc medium, so that the standard-quality moving picture data item (e.g., the moving picture data item having a resolution of SD) stored in the recording layer #1 is readable (block S117).

The system controlling processor 100 determines whether the video title name stored in the recording layer #1 of the disc medium 120 is the same as the video title name stored in the system memory 103 or the like (block S118). If the video title name stored in the disc medium 120 is not the same as the video title name stored in the system memory 103 or the like, that is, if the subject video title cannot be read, the process in the block S117 is executed again. If it is determined that the video title name stored in the disc medium 120 is the same as the video title name stored in the system memory 103 or the like (YES in block S118), the system controlling processor 100 executes a process of playing back the moving picture data item stored in the recording layer #1 based on the playback position information stored in the system memory 103 or the like and a process of displaying the details of the moving picture data item stored in the recording layer #1 (block S119). After executing the block S119, the system controlling processor 100 checks the amount of charge remaining in the battery 104 again (block S110). In the block S110, the amount of charge remaining in the battery 104 is periodically checked even when the moving picture data item is being played back.

If the disc medium 120 is of the type having a recording layer on each surface, the processes in the blocks S107, S108 and S117 are executed by acquiring the contents information from the disc medium 120.

As described above, in this embodiment, the playback available time to play back the subject moving picture data item is calculated on the basis of the charge remaining in the battery, the power consumption information, the format (e.g., the resolution) of the moving picture data item, etc. Then, the content list generated from the calculation results is displayed on the display screen of the information processing apparatus. Thus, the user can select a moving picture data item to be played back with reference to the content list displayed on the screen.

Further, even when a high-quality moving picture data item is being played back, the amount of charge remaining in the battery is checked periodically. As a result, the screen displays details of the moving picture data item currently played back (a playback available time in which the moving picture data item can be continuously played back, the recording layer storing the moving picture data item currently played back, etc.). In this embodiment, the recording layer #2 stores high-quality moving picture data items and the recording layer #1 stores standard-quality moving picture data items. Because the recording layer storing the moving picture data item currently played back is displayed, the user can visually recognize that either a high-quality moving picture data item or a standard-quality moving picture data item is played back.

Furthermore, the amount of charge remaining in the battery is periodically checked even when the moving picture data item stored in the recording layer #2 is being played back. If the amount of charge remaining in the battery is less than the predetermined threshold value, the computer 10 stops the moving picture data item currently played back, and displays a screen, through which the user selects a standard-quality moving picture data item of the same video title as that currently played back, so that the selected moving picture data item can be played back for a longer time from the stopped position. Thus, even if it is difficult to continuously play back a high-quality moving picture data item any longer, the user can designate and play back a standard-quality moving picture data item that can be played back for a longer time.

Moreover, if the disc medium 120 has a recording layer on each of the surfaces, the computer 10 acquires content information from the disk medium 120. Then, if it is determined, on the basis of the acquired content information, that the moving picture data item to be played back is not stored in the currently readable recording layer, the LCD panel 20 displays a screen to lead the user to turn over the disc medium 20. The user can visually recognize that it is necessary to turn over the disc medium 120 and insert it again in the optical disk drive 30.

In the above embodiment, the high-quality moving picture data items and the standard-quality moving picture data items corresponding to a video title are stored in the disk medium 120. However, they may be stored in the memory card 109 or the like. The video title currently played back and the playback position information may also be stored in the memory card 109 or the like, although they are stored in the DVD-RAM or the like in the above embodiment. Further, although the LCD panel 20 displays the item “estimated playback time” in the above embodiment, it may display the item “whether playback is possible” instead of the item “estimated playback time”.

Since the procedures of the playback process of the above embodiment are all implemented by a computer program, the advantages that are the same as those of the embodiment can easily be obtained by only introducing the computer program via a computer readable recording medium into a conventional computer.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus capable of playing back moving picture data from a disc medium of a two-layer structure including a first recording layer that stores a moving picture data item having a first resolution and a second recording layer that stores a moving picture data item having a second resolution, the information processing apparatus comprising:
a battery to drive the information processing apparatus;
an estimation processing portion to estimate an available time to play back the moving picture data item stored in the first recording layer by power from the battery and an available time to play back the moving picture data item stored in the second recording layer by power from the battery, based on an amount of charge remaining in the battery;
a display processing portion to display results of estimation by the estimation processing portion on a display screen of the information processing apparatus; and
a playback control portion to play back one selected by a user from the moving picture data item stored in the first recording layer and the moving picture data item stored in the second recording layer.

2. The information processing apparatus according to claim 1, wherein the estimation processing portion calculates the available time to play back the moving picture data item stored in the first recording layer by power from the battery and the available time to play back the moving picture data item stored in the second recording layer by power from the battery, based on the amount of charge remaining in the battery and power consumption information indicating power consumption per unit time for each of types of resolution.

3. The information processing apparatus according to claim 1, wherein the display processing portion displays on the display screen a content list including information indicative of the available time to play back the moving picture data item stored in the first recording layer estimated by the estimation processing portion, information indicative of the first resolution of the moving picture data item stored in the first recording layer, information indicative of the available time to play back the moving picture data item stored in the second recording layer estimated by the estimation processing portion, and information indicative of the second resolution of the moving picture data item stored in the second recording layer.

4. The information processing apparatus according to claim 1, wherein:
the playback control portion is configured to determine which of the first recording layer and the second recording layer stores the moving picture data item currently played back; and
the display processing portion displays information representing that the moving picture data item stored in the first recording layer is being played back, if it is determined that the moving picture data item currently played back is the moving picture data item stored in the first recording layer, and displays information representing that the moving picture data item stored in the second recording layer is being played back, if it is determined that the moving picture data item currently played back is the moving picture data item stored in the second recording layer.

5. The information processing apparatus according to claim 1, wherein:
the disc medium is a double-sided disc medium, which has the first recording layer formed on a first recording surface and the second recording layer formed on a second recording surface; and
the display processing portion detects which of the first recording surface and the second recording surface of the disc medium stores the moving picture data item selected by the user, and displays on the display screen a message which leads the user to turn over the disc medium, if the detected recording surface is not currently readable.

6. The information processing apparatus according to claim 1, wherein:
the estimation processing portion executes the estimation while the moving picture data item is being played back; and
the display processing portion displays on the display screen the results of the estimation executed while the moving picture data item is being played back.

7. The information processing apparatus according to claim 1, wherein:
the first resolution is higher than the second resolution;
the estimation processing portion executes the estimation while the moving picture data item having the first resolution is being played back, and determines whether the moving picture data item having the first resolution can be played back to the end, based on the results of the estimation executed while the moving picture data item having the first resolution is being played back; and
the display processing portion displays on the display screen a message that the moving picture data item having the first resolution cannot be played back to the end, and a message inquiring of the user whether to switch playback of the moving picture data item having the first resolution to playback of the moving picture data item having the second resolution stored in the second recording layer.

8. A playback control method applied to an information processing apparatus, which has a battery that drives the information processing apparatus and which plays back moving picture data from a disc medium of a two-layer structure including a first recording layer that stores a moving picture data item having a first resolution and a second recording layer that stores a moving picture data item having a second resolution, the method comprising:
estimating an available time to play back the moving picture data item stored in the first recording layer by power from the battery and an available time to play back the moving picture data item stored in the second recording layer by power from the battery, based on an amount of charge remaining in the battery;
displaying results of estimation by the estimating on a display screen of the information processing apparatus; and
playing back one selected by a user from the moving picture data item stored in the first recording layer and the moving picture data item stored in the second recording layer.

9. The playback control method according to claim 8, wherein the estimating includes calculating the available time to play back the moving picture data item stored in the first recording layer by power from the battery and the available time to play back the moving picture data item stored in the second recording layer by power from the battery, based on the amount of charge remaining in the battery and power consumption information indicating power consumption per unit time for each of types of resolution.

10. The playback control method according to claim 8, wherein the displaying includes displaying on the display screen a content list including information indicative of the available time to play back the moving picture data item stored in the first recording layer estimated by the estimation processing portion, information indicative of the first resolution of the moving picture data item stored in the first recording layer, information indicative of the available time to play back the moving picture data item stored in the second recording layer estimated by the estimation processing portion, and information indicative of the second resolution of the moving picture data item stored in the second recording layer.

11. The playback control method according to claim 8, wherein:
the playing back includes determining which of the first recording layer and the second recording layer stores the moving picture data item currently played back; and
the displaying includes displaying information representing that the moving picture data item stored in the first recording layer is being played back, if it is determined that the moving picture data item currently played back is the moving picture data item stored in the first recording layer, and displays information representing that the moving picture data item stored in the second recording layer is being played back, if it is determined that the moving picture data item currently played back is the moving picture data item stored in the second recording layer.

12. The playback control method according to claim 8, wherein:
the disc medium is a double-sided disc medium, which has the first recording layer formed on a first recording surface and the second recording layer formed on a second recording surface; and
the displaying includes detecting which of the first recording surface and the second recording surface of the disc medium stores the moving picture data item selected by the user, and displaying on the display screen a message which leads the user to turn over the disc medium, if the detected recording surface is not currently readable.

13. The playback control method according to claim 8, wherein:
the estimating includes executing the estimation while the moving picture data item is being played back; and
the displaying includes displaying on the display screen the results of the estimation executed while the moving picture data item is being played back.

14. The playback control method according to claim 8, wherein:
the first resolution is higher than the second resolution;
the estimating includes executing the estimation while the moving picture data item having the first resolution is being played back, and determining whether the moving picture data item having the first resolution can be played back to the end, based on the results of the estimation executed while the moving picture data item having the first resolution is being played back; and
the displaying includes displaying on the display screen a message that the moving picture data item having the first resolution cannot be played back to the end, and a message inquiring of the user whether to switch playback of the moving picture data item having the first resolution to playback of the moving picture data item having the second resolution stored in the second recording layer.
